(19) United States
(12) Patent Application Publication
(10) Pub. No.: US 2026/0075666 A1
(43) Pub. Date: Mar. 12, 2026

(54) SYSTEMS, METHODS, AND DEVICES FOR LIGHTWEIGHT WAKEUP WITH TOKEN

(71) Applicant: Apple Inc., Cupertino, CA (US)

(72) Inventors: Srinivasan BALASUBRAMANIAN, San Diego, CA (US); Babar QAISRANI, San Ramon, CA (US); Rohan C. MALTHANKAR, San Jose, CA (US); Sreevalsan VALLATH, Dublin, CA (US)

(21) Appl. No.: 18/830,064

(22) Filed: Sep. 10, 2024

(51) Int. Cl. H04W 76/11; H04W 52/02

(52) U.S. Cl. CPC H04W 76/11; H04W 52/02

(57) ABSTRACT

The techniques described herein can include solutions for lightweight wakeup with a token. A user equipment (UE) can receive a token associated with an origin and created by a token server. The UE can send the token to the origin server and can send the token and a UE identifier (ID) to a cellular gateway function. The cellular gateway function can receive a notification for the UE originating from the origin server, determine the UE ID associated with the token based on a mapping between the token and the UE ID, and forward the notification to a cellular network. The cellular network can communicate the notification to the UE, and the UE can determine whether to remain in a power saving mode or to enter an active state and receive the notification from the origin server.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks can be developed to implement fourth generation (4G), fifth generation (5G) or new radio (NR) technology. Such technology can include solutions for user equipment (UE) communications, such as communications between servers, cellular network components, and UEs. Messages from external servers can be routed via various devices to the UE.

### BRIEF DESCRIPTION OF THE DRAWINGS

The present disclosure will be readily understood and enabled by the detailed description and accompanying figures of the drawings. Like reference numerals can designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and can mean at least one, one or more, etc.

FIG. 1 is a diagram of an example of an overview according to one or more implementations described herein.

FIG. 2 is a diagram of an example network according to one or more implementations described herein.

FIG. 3 is a diagram of an example of token server(s) according to one or more implementations described herein.

FIG. 4 is a diagram of an example of cellular gateway function server(s) according to one or more implementations described herein.

FIG. 5 is a diagram of an example of a data structure for lightweight wakeup with a token according to one or more implementations described herein.

FIG. 6 is a diagram of an example of a process for lightweight wakeup with a token according to one or more implementations described herein.

FIG. 7 is a diagram of an example of a process for lightweight wakeup with a token according to one or more implementations described herein.

FIG. 8 is a diagram of an example of a process for lightweight wakeup with a token according to one or more implementations described herein.

FIG. 9 is a diagram of an example of components of a device according to one or more implementations described herein.

FIG. 10 is a diagram of example interfaces of baseband circuitry according to one or more implementations described herein.

FIG. 11 is a block diagram illustrating components, according to one or more implementations described herein, able to read instructions from a machine-readable or computer-readable medium (e.g., a non-transitory machine-readable storage medium) and perform any one or more of the methodologies discussed herein.

FIG. 12 is a diagram of an example process for lightweight wakeup with a token according to one or more implementations described herein.

FIG. 13 is a diagram of an example process for lightweight wakeup with a token according to one or more implementations described herein.

FIG. 14 is a diagram of an example process for lightweight wakeup with a token according to one or more implementations described herein.

### DETAILED DESCRIPTION

The following detailed description refers to the accompanying drawings. Like reference numbers in different drawings can identify the same or similar features, elements, operations, etc. Additionally, the present disclosure is not limited to the following description as other implementations can be utilized, and structural or logical changes made, without departing from the scope of the present disclosure.

Telecommunication networks can include user equipment (UEs) capable of communicating with base stations and/or other network access nodes. UEs and base stations can implement various techniques and communications standards for enabling UEs and base stations to discover one another, establish and maintain connectivity, and exchange information in an ongoing manner. Objectives of such techniques can include improved communications between UEs, base stations, and servers.

A UE can be connected to a cellular network. The UE can execute a software feature or application stored on the UE, which can cause the cellular network to establish a connection and channel between the UE and an application server that is external to the cellular network. An origin server, as referred to herein, can include an application server or another type of server that is external to a cellular network. The UE can frequently communicate with the external server to maintain the connection and/or channel between the UE and the origin server open and operable. However, since frequent communications can prevent the UE from entering a power saving mode of operation (e.g., an IDLE state, inactive state, idle mode, or inactive mode, sleep state or mode, etc.) maintaining connections and channels can be costly in terms of UE resources, cellular network resources, and more. Additionally, a UE identifier (ID) can be used to link the UE to information passing to and from the origin server. Communications flowing through the cellular network, therefore, can give rise to security and privacy concerns.

One or more of the techniques described herein can address the foregoing deficiencies by providing solutions for lightweight wakeup with a token. A lightweight wakeup signal can include a signal or message that notifies the receiving device of data (e.g., a message or notification) without causing the device to enter a wake state or connected state. For example, a lightweight wakeup signal can include a poke message or paging message. A token, as referred to herein, can include an identifier representing an instance of a communication session, data flow, channel, connection, or a combination thereof, between a UE and an origin server. A token can be referred to as a software token, an application token (or app token), etc., and/or can represent or otherwise be associated with an instance of a software feature, software application, process, or procedure involving communications between a UE and an origin server.

A token server can create a token to represent a connection and/or channel between a UE and an origin server. The token can be used as a token-specific identifier of the UE for use by the origin server, where the token is different than the UE identifier (ID) used to communicate with the cellular network and other entities. Thus, the origin server may not have access to the UE ID and other UE identifying information. A record of the token and associated UE ID can be stored at a gateway function that operates as a gateway or other type of interface between the devices forwarding information from the origin server to the UE. This can enable the UE to enter a power saving mode while a record of the connection and channel between the UE and origin server is maintained. While in a power saving mode, the UE can conserve power, and radio access network (RAN) resources as well as core network resources can be reassigned.

The origin server can identify notification data for the token at the origin server, and send a notification message with the token to the token server. The token server can initiate a wakeup signal by forwarding the notification with the token to the gateway function. The gateway function can map the token to the UE ID and forward the wakeup signal or message to the UE via the core network and RAN. The UE can receive the wakeup signal and respond by, for example, reconnecting to the network. The techniques described herein can use a token to enable a more efficient use of UE, RAN, and core network resources, while still enabling an origin server (or other type of external server) to initiate a wakeup signal directed to the UE. Additionally, the token can provide data security and user privacy as communications within the cellular network can be based on the UE ID, while communications outside the cellular network can be based on the token.

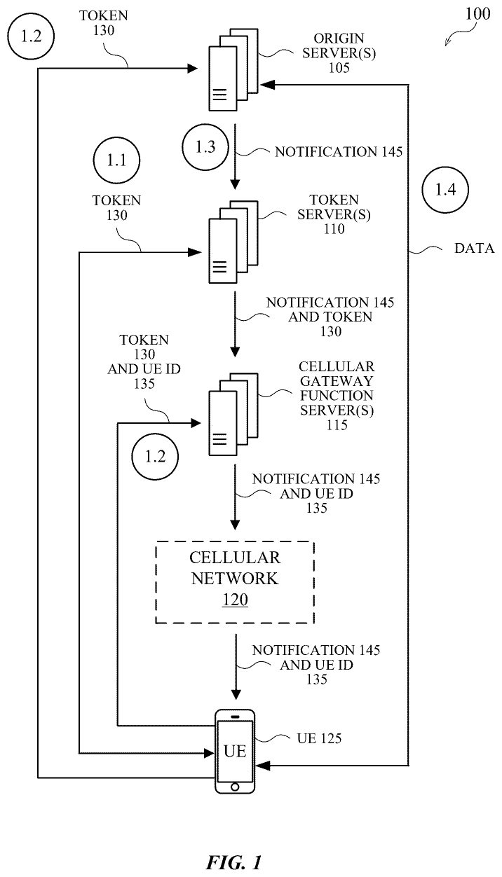

FIG. 1 is a diagram of an example of an overview 100 according to one or more implementations described herein. Overview 100 can include an example of lightweight wakeup with a token. Overview 100 can include devices such as origin server(s) 105, token server(s) 110, cellular gateway function server(s) 115, cellular network 120, and UE 125. Devices can share information such as token 130, UE ID 135, and notification 145. Token 130 and UE ID 135 can be implemented by various entities in conjunction with poke messages, or lightweight wakeups, to facilitate communications between origin server 105 and UE 125 while maintaining data security and user privacy. A poke or poke message, as referred to herein, can include a lightweight wakeup message between devices, such between origin server 105, token server 110, cellular gateway function server 115, and cellular network 120. In some examples, a poke (or poke message) can indicate data without causing wakeup of the receiving device. In some examples, a poke message can be an invitation message notifying the receiving device of available data.

Token 130 can be created by token server 110 and shared with UE 125 (at 1.1). The token can include information such as a token-specific UE identifier, information associated with cellular network 120, and information associated with applications at UE 125, among other information. UE 125 can share token 130 with origin server 105 and share token 130 and UE ID 135 with cellular gateway function server 115 (at 1.2). UE 125 can enter a power saving mode (e.g., idle state, inactive state). A notification of data 140 available for UE 125 (e.g., a notification for an application on UE 125) from origin server 105 can be forwarded through various entities until arriving at UE 125 (at 1.3). For example, origin server 105 can send notification 145 to token server 110.

In some examples, origin server 105 can include token 130 as part of notification 145 or in addition to notification 145. In some examples, origin server may not have information regarding UE ID 135, or other UE identification information. Token server 110 can send notification 145 and token 130 to cellular gateway function server 115 via a poke message. A poke message can be an example of a lightweight wakeup message.

In some examples, token server 110 can be multiple token servers 110, or one token server 110 of multiple token servers 110. In some examples, origin server 105 and token server 110 may not be distinct entities. For example, token server 110 may be included as part of origin server 105. In some examples, origin server 105 can include multiple application services, such as support multiple applications of UE 210.

Cellular gateway function server 115 can map the token 130 to UE ID 135 previously received from UE 125. Cellular gateway function server 115 can send notification 145 and UE ID 135 to cellular network 120 via a poke message. In some examples, cellular network 120 may not have token 130, and may not have other information regarding token server 110 and origin server 105. Cellular network 120 can send notification 145 and UE ID 135 to UE 125 using a paging message. UE 125 can respond to the paging message by, for example, exiting a power saving mode, reestablishing a connection with cellular network 120 and origin server 105 to send and receive data from origin server 105 (at 1.4).

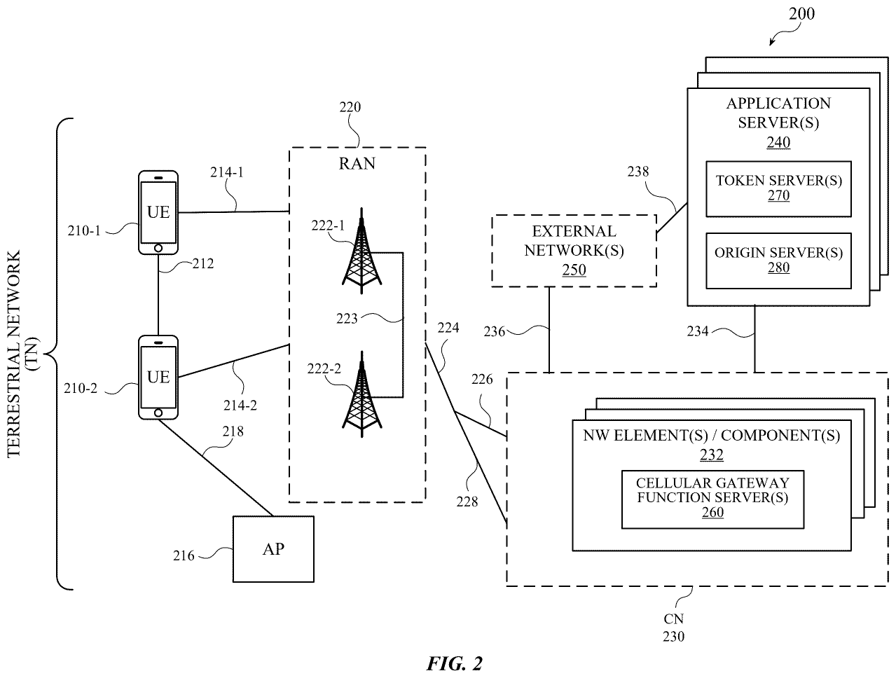

FIG. 2 is an example network 200 according to one or more implementations described herein. Example network 200 can include UEs 210, 210-2, etc. (referred to collectively as “UEs 210” and individually as “UE 210”), a radio access network (RAN) 220, a core network (CN) 230, application servers 240, and external networks 250.

The systems and devices of example network 200 can operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), and more.

As shown, UEs 210 can include smartphones (e.g., handheld touchscreen mobile computing devices connectable to one or more wireless communication networks). Additionally, or alternatively, UEs 210 can include other types of mobile or non-mobile computing devices capable of wireless communications, such as personal data assistants (PDAs), pagers, laptop computers, desktop computers, wireless handsets, etc. In some implementations, UEs 210 can include internet of things (IoT) devices (or IoT UEs) that can comprise a network access layer designed for low-power IoT applications utilizing short-lived UE connections. Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data can be a machine-initiated exchange, and an IoT network can include interconnecting IoT UEs (which can include uniquely identifiable embedded computing devices within an Internet infrastructure) with short-lived connections. In some scenarios, IoT UEs can execute background applications (e.g., keep-alive messages, status updates, etc.) to facilitate the connections of the IoT network.

UEs 210 can communicate and establish a connection with one or more other UEs 210 via one or more wireless channels 212, each of which can comprise a physical communications interface/layer. The connection can include an M2M connection, MTC connection, D2D connection, SL connection, etc. The connection can involve a PC5 interface. In some implementations, UEs 210 can be configured to discover one another, negotiate wireless resources between one another, and establish connections between one another, without intervention or communications involving RAN node 222 or another type of network node. In some implementations, discovery, authentication, resource negotiation, registration, etc., can involve communications with RAN node 222 or another type of network node.

UEs 210 can use one or more wireless channels 212 to communicate with one another. As described herein, UE 210 can communicate with RAN node 222 to request SL resources. RAN node 222 can respond to the request by providing UE 210 with a dynamic grant (DG) or configured grant (CG) regarding SL resources. A DG can involve a grant based on a grant request from UE 210. A CG can involve a resource grant without a grant request and can be based on a type of service being provided (e.g., services that have strict timing or latency requirements). UE 210 can perform a clear channel assessment (CCA) procedure based on the DG or CG, select SL resources based on the CCA procedure and the DG or CG; and communicate with another UE 210 based on the SL resources. The UE 210 can communicate with RAN node 222 using a licensed frequency band and communicate with the other UE 210 using an unlicensed frequency band.

UEs 210 can communicate and establish a connection with (e.g., be communicatively coupled) with RAN 220, which can involve one or more wireless channels 214-1 and 214-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different RAN network nodes (e.g., RAN network nodes 222-1 and 222-2) that can be connected via non-ideal backhaul (e.g., where one network node provides NR access and the other network node provides either E-UTRA for LTE or NR access for 5G). In such a scenario, one network node can operate as a master node (MN) and the other as the secondary node (SN). The MN and SN can be connected via a network interface, and at least the MN can be connected to the CN 230. Additionally, at least one of the MN or the SN can be operated with shared spectrum channel access, and functions specified for UE 210 can be used for an integrated access and backhaul mobile termination (IAB-MT). Similar for UE 210, the IAB-MT can access the network using either one network node or using two different nodes with enhanced dual connectivity (EN-DC) architectures, new radio dual connectivity (NR-DC) architectures, or the like. In some implementations, a base station (as described herein) can be an example of network RAN network nodes.

As shown, UE 210 can also, or alternatively, connect to access point (AP) 216 via connection interface 218, which can include an air interface enabling UE 210 to communicatively couple with AP 216. AP 216 can comprise a wireless local area network (WLAN), WLAN node, WLAN termination point, etc. The connection 214 can comprise a local wireless connection, such as a connection consistent with any IEEE 702.11 protocol, and AP 216 can comprise a wireless fidelity (Wi-Fi®) router or other AP. While not explicitly depicted in FIG. 2, AP 216 can be connected to another network (e.g., the Internet) without connecting to RAN 220 or CN 230. In some scenarios, UE 210, RAN 220, and AP 216 can be configured to utilize LTE-WLAN aggregation (LWA) techniques or LTE WLAN radio level integration with IPsec tunnel (LWIP) techniques. LWA can involve UE 210 in RRC_CONNECTED being configured by RAN 220 to utilize radio resources of LTE and WLAN. LWIP can involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling can include encapsulating the entirety of original IP packets and adding a new packet header, thereby protecting the original header of the IP packets.

RAN 220 can include one or more RAN nodes 222-1 and 222-2 (referred to collectively as RAN nodes 222, and individually as RAN node 222) that enable channels 214-1 and 214-2 to be established between UEs 210 and RAN 220. A RAN node 222 can be a base station and may be referred to herein as base station 222. RAN nodes 222 can include network access points configured to provide radio baseband functions for data and/or voice connectivity between users and the network based on one or more of the communication technologies described herein (e.g., 2G, 3G, 4G, 5G, WiFi®, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 can include a roadside unit (RSU), a transmission reception point (TRxP or TRP), and one or more other types of ground stations (e.g., terrestrial access points). In some scenarios, RAN node 222 can be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, can be implemented as one or more software entities running on server computers as part of a virtual network, which can be referred to as a centralized RAN (CRAN) and/or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 2 (L2) protocol entities can be operated by individual RAN nodes 222; a media access control (MAC)/physical (PHY) layer split wherein RRC, PDCP, radio link control (RLC), and MAC layers can be operated by the CRAN/vBBUP and the PHY layer can be operated by individual RAN nodes 222; or a “lower PHY” split wherein RRC, PDCP, RLC, MAC layers and upper portions of the PHY layer can be operated by the CRAN/vBBUP and lower portions of the PHY layer can be operated by individual RAN nodes 222. This virtualized framework can allow freed-up processor cores of RAN nodes 222 to perform or execute other virtualized applications.

In some implementations, an individual RAN node 222 can represent individual gNB-distributed units (DUs) connected to a gNB-control unit (CU) via individual F1 or other interfaces. In such implementations, the gNB-DUs can include one or more remote radio heads or radio frequency (RF) front end modules (RFEMs), and the gNB-CU can be operated by a server (not shown) located in RAN 220 or by a server pool (e.g., a group of servers configured to share resources) in a similar manner as the CRAN/vBBUP. Additionally, or alternatively, one or more of RAN nodes 222 can be next generation eNBs (i.e., gNBs) that can provide evolved universal terrestrial radio access (E-UTRA) user plane and control plane protocol terminations toward UEs 210, and that can be connected to a 5G core network (5GC) 230 via an NG interface.

Any of the RAN nodes 222 can terminate an air interface protocol and can be the first point of contact for UEs 210. In some implementations, any of the RAN nodes 222 can fulfill various logical functions for the RAN 220 including, but not limited to, radio network controller (RNC) functions such as radio bearer management, uplink and downlink dynamic radio resource management and data packet scheduling, and mobility management. UEs 210 can be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals can comprise a plurality of orthogonal subcarriers.

In some implementations, a downlink resource grid can be used for downlink transmissions from any of the RAN nodes 222 to UEs 210, and uplink transmissions can utilize similar techniques. The grid can be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block can comprise a collection of resource elements (REs); in the frequency domain, this can represent the smallest quantity of resources that currently can be allocated. There are several different physical downlink channels that are conveyed using such resource blocks.

Further, RAN nodes 222 can be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum can correspond to channels or frequency bands selected, reserved, regulated, etc., for certain types of wireless activity (e.g., wireless telecommunication network activity), whereas an unlicensed spectrum can correspond to one or more frequency bands that are not restricted for certain types of wireless activity. Whether a particular frequency band corresponds to a licensed medium or an unlicensed medium can depend on one or more factors, such as frequency allocations determined by a public-sector organization (e.g., a government agency, regulatory body, etc.) or frequency allocations determined by a private-sector organization involved in developing wireless communication standards and protocols, etc.

The PDSCH can carry user data and higher layer signaling to UEs 210. The physical downlink control channel (PDCCH) can carry information about the transport format and resource allocations related to the PDSCH channel, among other things. The PDCCH can also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) can be performed at any of the RAN nodes 222 based on channel quality information fed back from any of UEs 210. The downlink resource assignment information can be sent on the PDCCH used for (e.g., assigned to) each of UEs 210.

One or more of the techniques, described herein, can enable UE 210 to receive a token created by token server 270. UE 210 can share the token with origin server 280 and cellular gateway function server 260. UE 210 can further indicate a UE ID to cellular gateway function server 260. Cellular gateway function server 260 can use a mapping of the token to the UE ID to route information from origin server 280 to UE 210. These and many other features and aspects of the techniques described herein are presented below with reference to remaining Figures.

The RAN nodes 222 can be configured to communicate with one another via interface 223. In implementations where the system is an LTE system, interface 223 can be an X2 interface. In NR systems, interface 223 can be an Xn interface. The X2 interface can be defined between two or more RAN nodes 222 (e.g., two or more eNBs/gNBs or a combination thereof) that connect to evolved packet core (EPC) or CN 230, or between two eNBs connecting to an EPC. The RAN nodes 222 can be configured to communicate with the CN 230 via various interfaces, such as physical interfaces, including interface 224, interface 226, and interface 228.

As shown, RAN 220 can be connected (e.g., communicatively coupled) to CN 230. CN 230 can comprise a plurality of network elements 232, which are configured to offer various data and telecommunications services to customers/subscribers (e.g., users of UEs 210) who are connected to the CN 230 via the RAN 220. In some examples, network elements 232 can include cellular gateway function server 260.

In some examples, cellular gateway function server 260 can include a function or device that exists as part of an access management function (AMF), session initiation protocol (SIP), CN 230, or another protocol or device. Cellular gateway function server 260 (e.g., cellular gateway function) can be built into an existing function or device or exist as a separate function or device. Cellular gateway function server 260 can receive notification of a token (e.g., app token) and UE identifier (ID) from UE 210. Cellular gateway function server 260 can store each registered token in association with UE 210. For example, cellular gateway function server 260 can maintain a table that maps each token to an associated origin server and UE 210 (e.g., a UE ID).

In some examples, cellular gateway function server 260 (e.g., cellular gateway function) can receive a notification from token server 270. The notification can originate at origin server 280 and be forwarded by token server 270 to cellular gateway functions server 260. In some examples, token server 270 can be a part of a different application server 240 than origin server 280. For example, token server 270 can be part of a first application server 240 and origin server 280 can be part of a second application server 240. In some examples, token server 270 and origin server 280 can be a part of another component (e.g., external network 250) or be independent components. Cellular gateway function server 260 can retrieve the UE ID mapped to the received token and indicate a lightweight wakeup to the cellular network (which can include RAN 220) that includes the UE ID of UE 210. In some examples, the cellular network can include a cellular core control plane and a cellular core user plane.

In some implementations, CN 230 can include an evolved packet core (EPC), a 5G CN, and/or one or more additional or alternative types of CNs. The components of the CN 230 can be implemented in one physical node or separate physical nodes including components to read and execute instructions from a machine-readable or computer-readable medium (e.g., a non-transitory machine-readable storage medium). In some implementations, network function virtualization (NFV) can be utilized to virtualize any or all the above-described network node roles or functions via executable instructions stored in one or more computer-readable storage mediums (described in further detail below). A logical instantiation of the CN 230 can be referred to as a network slice, and a logical instantiation of a portion of the CN 230 can be referred to as a network sub-slice. NFV architectures and infrastructures can be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

As shown, CN 230, application servers 240, and external networks 250 can be connected to one another via interfaces 234, 236, and 238, which can include IP network interfaces. Application servers 240 can include one or more server devices or network elements (e.g., virtual network functions (VNFs) offering applications that use IP bearer resources with CN 230 (e.g., universal mobile telecommunications system packet services (UMTS PS) domain, LTE PS data services, etc.). Application servers 240 can also, or alternatively, be configured to support one or more communication services (e.g., voice over IP (VoIP) sessions, push-to-talk (PTT) sessions, group communication sessions, social networking services, etc.) for UEs 210 via the CN 230. In some examples, external networks 250 can include token server(s) 270, origin server(s) 280, or a combination thereof.

Similarly, external networks 250 can include one or more of a variety of networks, including the Internet, thereby providing the mobile communication network and UEs 210 of the network access to a variety of additional services, information, interconnectivity, and other network features. In some examples, application servers 240 can include token server 270 and origin server 280. Token server 270 can create a token (e.g., app token), which can be communicated by UE 210 to cellular gateway function server 260 and origin server 280. Origin server 280 can send a notification for UE 210 to token server 270 for forwarding to UE 210. Origin server 280 can include the token as part of the message to token server 270. Token server 270 can forward the notification and token to cellular gateway function server 260.

In some examples, cellular gateway function server 260, token server 270, and origin server 280 can be a part of external networks 250, application servers 240, network elements 232, or a combination thereof. For example, cellular gateway function server 260 can be a part of external network 250.

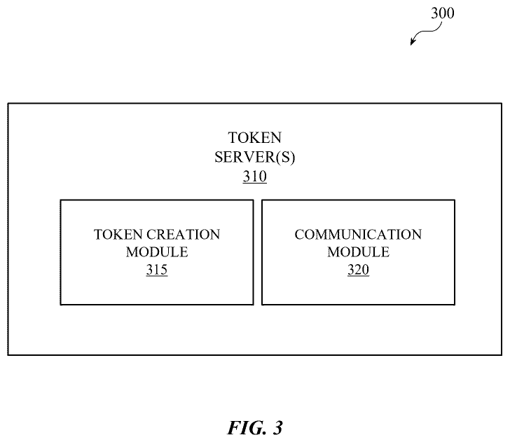

FIG. 3 is a diagram of an example of token server(s) 310 according to one or more implementations described herein. As shown, token server 310 can include token creation module 315 and communication module 320. A module can include hardware, software, or a combination of hardware and software. Examples of the hardware can include a memory device and one or more processors. The memory device can store instructions that are executable by the one or more processors. In some implementations, token server 310 can include one or more additional, fewer, alternative, or alternatively arranged modules than shown in FIG. 3.

Token creation module 315 can be configured to create a token associated with an application and associated origin server 280. In some examples, the token can be a hash function. In some examples, token creation module 315 can be configured to create multiple tokens, where each token can be associated with an application. The token can include a token-specific UE identifier, associated cellular network operators and/or carriers, an application identifier, other application specific information, and other metadata.

For example, the token can include secured UE identification data, which can hide identifying information about UE 210 while allowing for UE identification data to be routed from token server 310 to UE 210 via cellular networks. In some examples, cellular networks can include base station 222, a cellular core control plane, a cellular core user plane, etc. For example, the token can include a token-specific UE identifier that can be used by origin server 280 to identify notifications for UE 210 without the UE ID. A mapping of the UE ID and token can be provided by UE 210 to the cellular gateway function.

The token can include cellular network connection data (e.g., metadata), such as when to establish a connection with the cellular network and when not to establish a connection with the cellular network. The token can further identify which cellular network carrier, mobile network operator (MNO), or both, to use for communications within the cellular network. The carrier/MNO information can be used by the cellular gateway function to contact the correct carrier/MNO for routing information to UE 210.

In some examples, the token can include thresholds, such as delay thresholds, that can indicate to the cellular network an acceptable delay threshold for delivery to UE 210. An acceptable delay threshold can indicate to the cellular network a time between reception of the token and transmission of the token to UE 210. In some examples, the token can indicate whether a cellular network connection, or radio connection, can be established with UE 210. In some examples, the token can include additional identifying data, such as an application identifier associated with the application at UE 210. In some examples, the token can include other application specific information. Application identifier information can be used by UE 210 and the token server, and can be unknown, or hidden, from the cellular network.

Communication module 320 can be configured to receive and transmit (e.g., output) messages that can include the token. Communication module 320 can be configured to receive messages from origin server (e.g., origin server 280), UE 210, and cellular gateway function server, among other devices and entities. In some examples, communication module 320 can be configured to output the token to UE 210. The token can correspond to origin server 280. In some examples, communication module 320 can be configured to communicate multiple tokens corresponding to respective origin servers 280 to UE 210. Communication module 320 can be configured to receive a message from origin server that includes the token and a notification for UE 210. Communication module 320 can be configured to transmit a message to cellular gateway function server, where the message includes the notification from origin server 280 and the token.

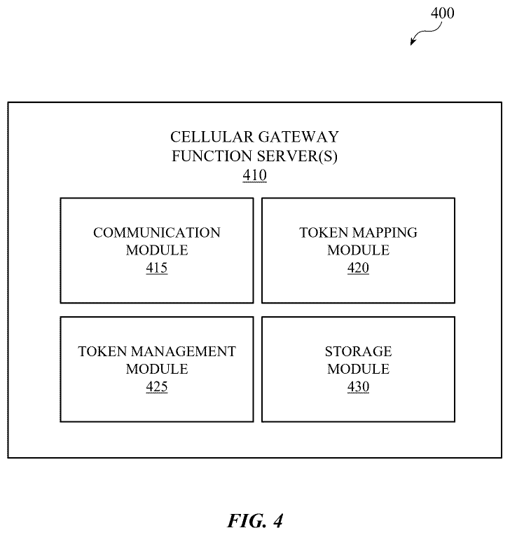

FIG. 4 is a diagram of an example of cellular gateway function server(s) 410 (e.g., cellular gateway function) according to one or more implementations described herein. As shown, cellular gateway function server 410 can include communication module 415, token mapping module 420, token management module 425, and storage module 430. A module can include hardware, software, or a combination of hardware and software. Examples of the hardware can include a memory device and one or more processors. The memory device can store instructions that are executable by the one or more processors. In some implementations, cellular gateway function server 410 can include one or more additional, fewer, alternative, or alternatively arranged modules than shown in FIG. 4.

Communication module 415 can be configured to receive and transmit (e.g., output) messages that can include a token. Communication module 415 can be configured to receive messages from the token server, UE 210, origin server 280, and cellular network (e.g., cellular core control plane, cellular core user plane, base station 222), among other devices and entities. In some examples, communication module 415 can be configured to receive the token and UE ID from UE 210. The token can be associated with origin server (e.g., origin server 280) via an identifier, address, and/or gateway port. In some examples, communication module 415 can be configured to receive multiple tokens corresponding to a single origin server 280. Communication module 415 can be configured to receive a message from the token server that includes the token and a notification for UE 210 that originated at origin server 280. In some examples, communication module 415 can be a message including the notification from origin server 280 and the UE ID of UE 210.

Token mapping module 420 can be configured to map the token to the UE ID. In some examples, token mapping module 420 can be configured to map the token and UE ID communicated by UE 210. For example, token mapping can include creating a table that associates the received token with the received UE ID. In some examples, token mapping module 420 can be configured to map multiple tokens from UE 210. In some examples, token mapping module can include registering a creating a domain name system (DNS) lookup and registering the token mapping with the DNS.

Token management module 425 can be configured to access the token mapping. For example, token management module 425 can be configured to store tokens, monitor an age/usage of tokens, and/or remove tokens. For example, token management module 425 can be configured to delete a token in response to one or more events or triggers, such as when a token has not been used within a threshold period of time, in response to a notification to delete or discontinue a connection or channel between UE 210 and origin server 280, etc. Storage module 430 can be configured to store the token mapping, as well as other information. For example, storage module 430 can store information, such as a record of the UE ID and the token, when communications are received and sent, when the token mapping is accessed, among other examples.

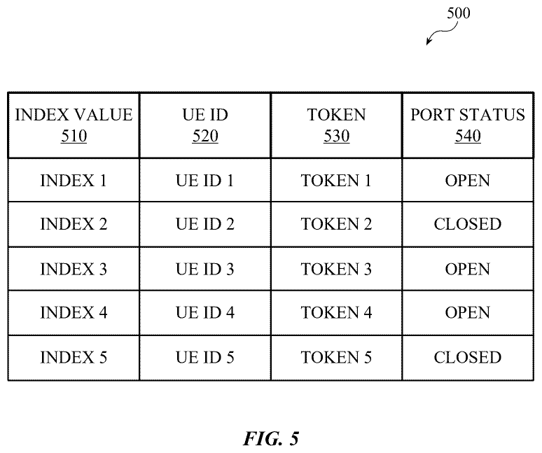

FIG. 5 is a diagram of an example of a data structure for lightweight wakeup with a token according to one or more implementations described herein. FIG. 5 can describe an example of token mapping at the cellular gateway function server (e.g., cellular gateway function). For example, token mapping can include index value 510, UE ID 520, token 530, and port status 540. In some implementations, token mapping can include one or more additional, fewer, alternative, or alternatively arranged components than shown in FIG. 5.

In some examples, the cellular gateway function can receive UE IDs 520 and tokens 530 from UE 210. For example, UE 210 can retrieve token 530 created by the token server and notify the cellular gateway function of token 530 and UE ID 520 of UE 210. Cellular gateway function can store token 530 as token 1, and UE ID 520 as UE ID 1, which can both correspond index 1. Cellular gateway function can store multiple tokens 530 corresponding to one or more UEs 210. For example, UE ID 2 can correspond to token 530. In some examples, multiple UEs 210 can have multiple tokens 530. For example, UE ID 1 and UE ID 2 can be the same UE ID 520 of the same UE 210, the UE 210 indicating multiple tokens 530.

For each received token 530 and UE ID 520 received, there can be a corresponding port status 540. Port status 540 can be determined by UE wake state. For example, when UE 210 is in a power saving mode (e.g., an inactive mode, an idle mode) the port status can be closed. When UE 210 is in a wake state, such as a connected mode, UE 210 can communicate messages and the port status can be open.

In some examples, cellular gateway function can receive a notification and token 530 from the token server. Cellular gateway function can determine which token 530 was received, such as token 3, and the corresponding UE ID 3. The notification can then be forwarded to the cellular network with the UE ID 3. By including the UE ID 3, and refraining from including token 3, anonymity of the origin server and token server are maintained, while UE ID 3 indicates which UE 210 to send the notification.

By receiving tokens 530 and maintaining the token mapping, port status 540 can be closed, and information can still be routed to UE 210. For example, UE 210 may not continue to send messages to servers or the cellular network to maintain an open port status 540. Instead, UE 210 can enter a power saving mode (e.g., inactive mode, sleep mode, idle mode, disconnected mode, lower power mode, power saving state, etc.), and cellular gateway function can facilitate routing of information from servers (e.g., origin servers) to UE 210 securely.

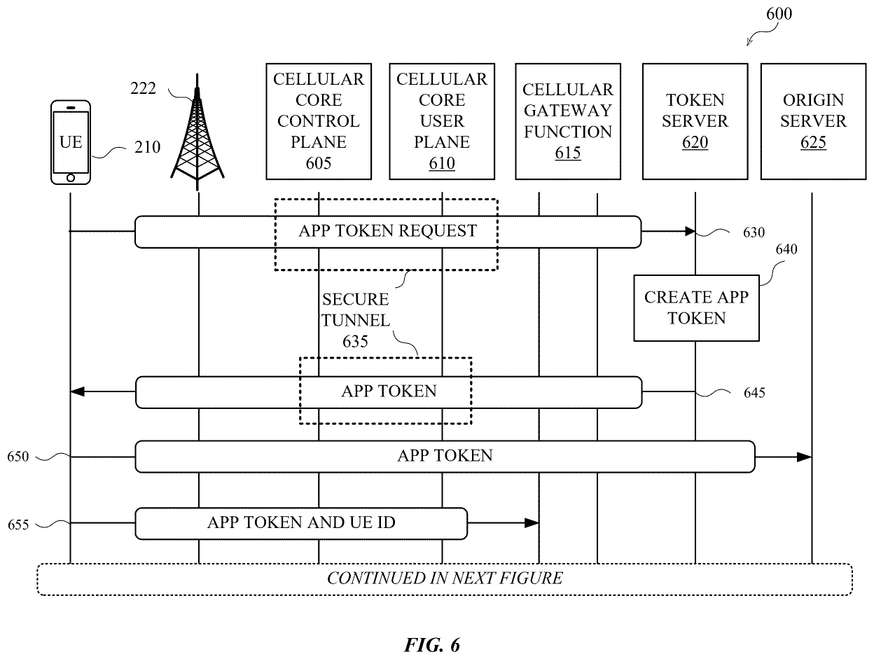

FIG. 6 is a diagram of an example of process 600 for lightweight wakeup with a token according to one or more implementations described herein. Process 600 can be implemented by UE 210. In some implementations, some or all of process 600 can be performed by, or be an example of, one or more other systems or devices, including one or more of the devices of FIG. 2. Additionally, process 600 can include one or more fewer, additional, differently ordered and/or arranged operations than those shown in FIG. 6. In some implementations, some or all of the operations of process 600 can be performed independently, successively, simultaneously, etc., of one or more of the other operations of process 600. As such, the techniques described herein are not limited to a number, sequence, arrangement, timing, etc., of the operations or processes depicted in FIG. 6.

Process 600 can include establishing secure tunnel 635 and requesting a token (at 630). For example, UE 210 can establish a secure tunnel 635 with token server 620 and request a token from token server 620. The token can be requested regarding a specific application associated with UE 210 and origin server 625.

Process 600 can include creating the token (at 640). For example, token server 620 can create the token. The token can hide identifying UE 210 information and can be associated with a specific application and/or origin server 625. The token can include metadata regarding routing data from origin server 625 to UE 210. For example, the token can include information regarding when to establish and when not to establish a connection, which can result in optimization of data delivery.

The token can further include information regarding the carrier, MNO, or both, to be used for communication with UE 210, among other information that can be used for routing information from token server 620 to UE 210. Routing can include sharing information through cellular gateway function 615, cellular core control plane 605, and base station 222, which can be components of a cellular network. In some examples, the token can include information associated with whether messages are aggregated and the size or number of the aggregated message.

Process 600 can include transmitting the token to UE 210 (at 645). For example, token server 620 can transmit (e.g., send, output, communicate) the created token to UE 210. Process 600 can include registering (e.g., transmitting, notification, sending, sharing, outputting) the token to origin server (at 650). For example, UE 210 can share the token created by token server 620 with origin server 625. The token can include information associated with origin server 625. In some examples, the communication of the token can be via one or more packets or one or more packet headers. The token can function as an identifier of UE 210 for origin server 625 to identify UE 210. Origin server 625 can be a server associated with an application at UE 210.

Process 600 can include indicating the token and UE ID to cellular gateway function 615 (e.g., cellular gateway function server) (at 655). For example, UE 210 can indicate the token and ID of UE 210 to cellular gateway function 615. Cellular gateway function 615 can map the token and UE ID of UE 210 and store a record that maps the UE ID to the token. In some examples, UE 210 can share tokens for each origin server 625 of multiple origin servers 625 and notify cellular gateway function 615 of each token.

In some examples, the token mapping of cellular gateway function 615 can maintain the association between origin server 625 and UE 210, such that UE 210 can receive data routed from origin server 625 through token server 620 and base station 222. UE 210 can receive data without entering a wake state to maintain an open connection with base station 222 and token server 620, as cellular gateway function 615 stores information for data transfer.

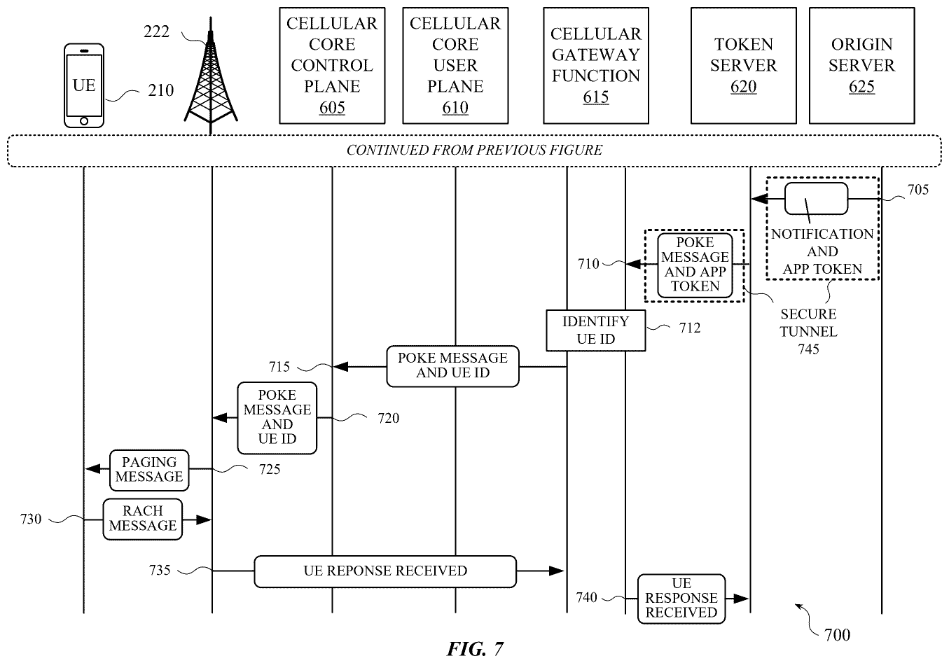

FIG. 7 is a diagram of an example of process 700 for lightweight wakeup with a token according to one or more implementations described herein. Process 700 can be implemented by UE 210. In some implementations, some or all of process 700 can be performed by one or more other systems or devices, including one or more of the devices of FIG. 2. Additionally, process 700 can include one or more fewer, additional, differently ordered and/or arranged operations than those shown in FIG. 7. In some implementations, some or all of the operations of process 700 can be performed independently, successively, simultaneously, etc., of one or more of the other operations of process 700. As such, the techniques described herein are not limited to a number, sequence, arrangement, timing, etc., of the operations or processes depicted in FIG. 7. In some examples, process 700 can be a continuation of FIG. 6.

Process 700 can include a notification transmitted by origin server 625 to token server 620 (at 705). The notification can be indicated via secure tunnel 745. The notification can include the token and an indication that that there is notification data available for UE 210 (e.g., incoming data traffic associated with the token) at origin server 625. As origin server 625 indicates the token to token server 620 for further routing to UE 210, origin server 625 determines when routing occurs. In some examples, origin server 625 interacts with the token as a single value.

In some examples, origin server 625 can function as the token and can interface directly with the cellular network (e.g., cellular core control plane 605, cellular core user plane 610, base station 222). In such examples, origin server 625 may not communicate with various entities, such as token server 620.

Process 700 can include indicating the notification to cellular gateway function 615 (e.g., cellular gateway function server) via a poke message (at 710). For example, token server 620 can forward the notification from origin server 625 to cellular gateway function 615. In some examples, the token can include carrier information (e.g., a carrier number, carrier identifier, MNO core network) that token server 620 identifies and forwards to cellular gateway function 615. A poke message can be a lightweight wakeup message, such as a page (e.g., page reason) or mobile terminated-small data transmission (MD-SDT), and can include the token and notification. A page reason can provide information associated with whether or not UE 210 establishes a connection with base station 222 or refrains from establishing a connection. MT-SDT can indicate information, such as notification data, to UE 210 without UE 210 establishing a connection (e.g., RRC connection) with base station 222. In some examples, the poke message can include the carrier number included in the token for routing to UE 210. In some examples, token server 620 communicates with the cellular gateway function 615 via the identified carrier. In some examples, token server 620 and UE 210 can identify additional token information, such as application identifier information and other application specific information, that can be hidden (e.g., opaque, unidentifiable, unknown) from other entities.

Cellular gateway function 615 receives the token and the associated meta data via secure tunnel 745. Secure tunnel 745 can hide internal information from external sources. Cellular gateway function can translate the token to a UE ID (e.g., cellular network identifier). This translation can be done by identifying the UE ID mapped to the token.

Process 700 can include identifying the UE ID (at 712). For example, cellular gateway function 615 can receive the token and identify, via the token mapping, which UE ID is associated with the token. Process 700 can include a transmitting a poke message, or lightweight wakeup that includes the notification and UE ID (at 715). For example, cellular gateway function 615 can send a poke message that includes the notification and the UE ID to cellular core control plane 605. By transmitting a poke message, cellular gateway function 615 may not be waking up the UE 210, and instead can be indicating a lightweight wakeup. This allows for the connection from UE 210 to base station 222 and connection between UE 210 and token server 620 to be maintained when UE 210 may not be in an active mode (e.g., connected mode) and may not be consistently indicating messages (e.g., in an inactive mode).

Process 700 can include transmitting a poke message that includes the notification and UE ID to base station 222 (at 720). For example, cellular core control plane 605 can send a poke message to base station 222. The poke message can be a lightweight wakeup message. Process 700 can include paging UE 210 (at 725). For example, base station 222 can page UE 210 by sending a paging message (e.g., lightweight wakeup message). The lightweight wakeup message can indicate the notification data from origin server 625. In some examples, the paging message (e.g., lightweight wakeup message) can include the notification data as part of a payload of the page, and can include information associated with whether or not UE 210 establishes a connection with base station 222 or refrains from establishing a connection. In some examples, UE 210 can receive the paging message while in a power saving mode (e.g., lower power mode, power saving state, inactive mode, idle mode). In some examples, the lightweight wakeup message can be a MT-SDT. MT-SDT can indicate information, such as notification data, to UE 210 without UE 210 establishing a connection (e.g., RRC connection) with base station 222. In some examples, MT-SDT can be received while UE 210 is in a power saving mode (e.g., inactive mode).

UE 210 can indicate a first message of a random access channel (RACH) procedure to base station 222 (at 730). That is, UE 210 can indicate that the message was received, but may not establish a connection with base station 222. Thus, UE 210 can remain in a power saving mode, receiving the page, that is a lightweight wakeup message, rather than consistently entering an active state to (e.g., connected mode, RRC connected mode) transmit communications to verify token server 620. UE 210 can determine to refrain from establishing an RRC connection based on the page message.

In some examples, the paging message can be based on space restrictions. For example, when supporting an inactive mode (e.g., power saving mode, idle mode), UE 210 can support mobile terminated small data transmission (MTSDT) functions. By indicating a paging message, base station 222 facilitates UE 210 remaining in an inactive mode and continuing to support MTSDT.

Process 700 can include indicating to cellular gateway function 615 that the UE response was received (at 735). The UE response can be received without establishing a connection with the network. Cellular gateway function 615 can send a notification to token server 620 that the UE response was received (at 740). Token server 620 can receive the indication that the UE response was received, and refrain from retransmitting the notification from the origin server 325.

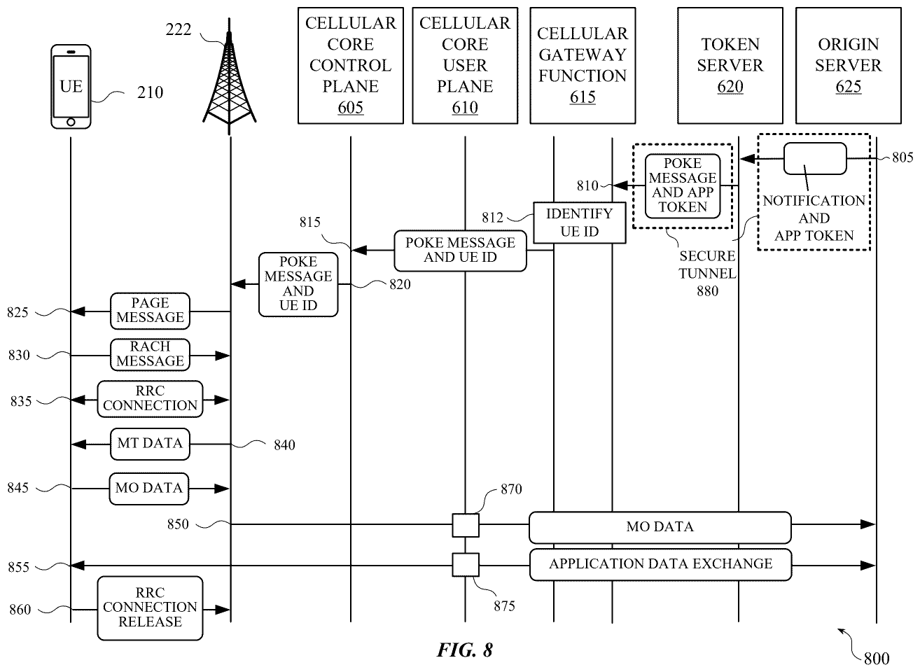

FIG. 8 is a diagram of an example of process 800 for lightweight wakeup with a token according to one or more implementations described herein. Process 800 can be implemented by UE 210. In some implementations, some or all of process 800 can be performed by one or more other systems or devices, including one or more of the devices of FIG. 2. Additionally, process 800 can include one or more fewer, additional, differently ordered and/or arranged operations than those shown in FIG. 8. In some implementations, some or all of the operations of process 800 can be performed independently, successively, simultaneously, etc., of one or more of the other operations of process 800. As such, the techniques described herein are not limited to a number, sequence, arrangement, timing, etc., of the operations or processes depicted in FIG. 8. Process 800 describes UE 210 connecting with origin server 625 to retrieve notification data. In some implementations, some or all of the operations of process 800 can be examples of operations of FIG. 7.

Process 800 can include indicating a notification and token to token server 620 (at 805). For example, origin server 625 can have notification data for UE 210, and can send a notification that there is notification data to token server 620. Origin server 625 can communicate the notification and token to token server 620 via secure tunnel 880. Process 800 can include forwarding the notification via a poke message with the token to cellular gateway function 615 (at 810). For example, token server 620 can send a lightweight wakeup message, or poke message, with the token to cellular gateway function 615 via secure tunnel 880.

Process 800 can include identifying the UE ID (at 812). For example, cellular gateway function 615 can identify the UE ID associated with the token based on the token table. Process 800 can include sending a poke message and UE ID to cellular core control plane 605 (at 815). For example, cellular gateway function 615 can indicate a lightweight wakeup message, or poke message that includes the notification and the identified UE ID to cellular core control plane 605.

Process 800 can include transmitting a poke message and UE ID to bases station 222 (at 820). For example, cellular core control plane 605 can transmit a poke message that includes the notification and UE ID to base station 222. Process 800 can include transmitting a page message (at 825). For example, base station 222 can transmit a page message to UE 210 based on the UE ID received from cellular core control plane 605. The page message can include the notification that has been routed from origin server 625.

Process 800 can include a RACH message (at 830). For example, in response to the page message, UE 210 can send a first RACH message to base station 222. In some examples, process 800 can include establishing an RRC connection (at 835). For example, UE 210 can establish enter an active mode (e.g., connected mode, RRC connected mode), or establish an RRC connection with base station 222. UE 210 can determine to establish the RRC connection based on the page message.

Process 800 can include exchanging mobile terminated (MT) data and mobile originated (MO) data (at 840 and 845). For example, base station 222 can send MT data to UE 210, and UE 210 can respond with MO data. MT data can include mobile messages, voice calls, and other data from base station 222. MO data can include mobile messages, voice calls, and other data from UE 210.

Process 800 can include communicating MO data with origin server 625 (at 850). For example, UE 210 can send MO data to origin server 625 to establish a connection. The connection can be routed through cellular core user plane 610 (at 870). Process 800 can include application data exchange (at 855). For example, UE 210 can retrieve the notification data from origin server 625. The data can be routed through cellular core user plane 610 (at 875). Application data exchange can include data sent from UE 210 to origin server 625, such as an interaction with the notification data or actions associated with an application of UE 210. In some examples, application data exchange can include receiving additional data associated with origin server 625, such as data associated with running an application of UE 210.

Process 800 can include releasing the RRC connection (at 860). For example, UE 210 can release, or terminate, the RRC connection after retrieving the notification data from origin server 625. For instance, UE 210 can terminate an application running locally on UE 210. The application can involve communications between UE 210 and origin server 625. And in response to terminating the application, UE 210 can notify base station 222 of an RRC connection release to terminate the RRC connection for the application.

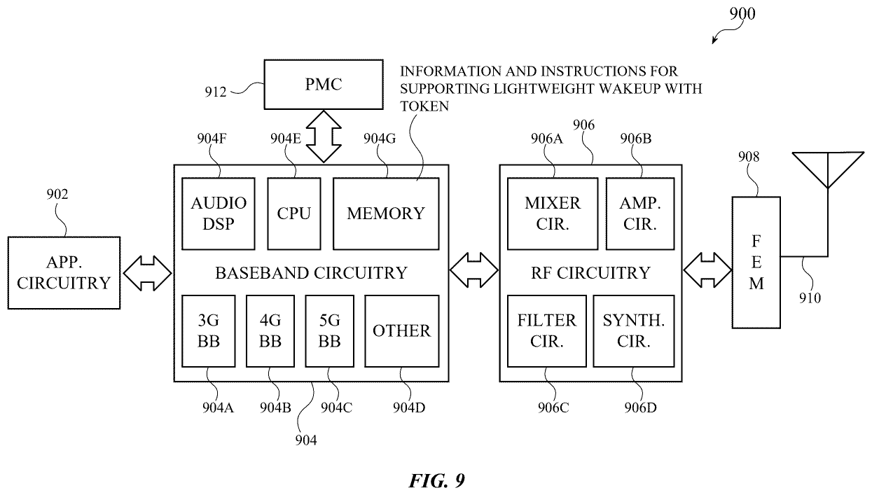

FIG. 9 is a diagram of an example of components of a device according to one or more implementations described herein. In some implementations, the device 900 can include application circuitry 902, baseband circuitry 904, RF circuitry 906, front-end module (FEM) circuitry 98, one or more antennas 910, and power management circuitry (PMC) 912 coupled together at least as shown. In some implementations, device 900 can include fewer elements (e.g., a RAN node may not utilize application circuitry 902, and can instead include a processor/controller to process data received from a core network. In some implementations, device 900 can include additional elements such as, for example, memory/storage, display, camera, sensor (including one or more temperature sensors, such as a single temperature sensor, a plurality of temperature sensors at different locations in device 900, etc.), or input/output (I/O) interface. In other implementations, the components described below can be included in more than one device (e.g., said circuitries can be separately included in more than one device for cloud-RAN (C-RAN) implementations).

The application circuitry 902 can include one or more application processors. For example, the application circuitry 902 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 900. In some implementations, processors of application circuitry 902 can process data packets received from a core network.

The baseband circuitry 904 can include circuitry such as, but not limited to, one or more single-core or multi-core processors. Baseband circuitry 904 can include one or more baseband processors or control logic to process baseband signals received from a receive signal path of RF circuitry 906 and to generate baseband signals for a transmit signal path of RF circuitry 906. Baseband circuitry 904 can interface with application circuitry 902 for generation and processing of the baseband signals and for controlling operations of RF circuitry 906. For example, in some implementations, baseband circuitry 904 can include a 3G baseband processor 904A, a 4G baseband processor 904B, a 5G baseband processor 904C, or other baseband processor(s) 904D for other existing generations, generations in development or to be developed in the future (e.g., 5G, 6G, 7G, etc.). Baseband circuitry 904 (e.g., one or more of baseband processors 904A-D) can handle various radio control functions that enable communication with one or more radio networks via RF circuitry 906. In other implementations, some or all of the functionality of baseband processors 904A-D can be included in modules stored in memory 804G and executed via a central processing unit (CPU) 804E. The radio control functions can include, but are not limited to, signal modulation/demodulation, encoding/decoding, radio frequency shifting, etc. In some implementations, modulation/demodulation circuitry of baseband circuitry 804 can include Fast-Fourier Transform (FFT), precoding, or constellation mapping/de-mapping functionality. In some implementations, encoding/decoding circuitry of baseband circuitry 804 can include convolution, tail-biting convolution, turbo, Viterbi, or low-density parity check (LDPC) encoder/decoder functionality. Implementations of modulation/demodulation and encoder/decoder functionality are not limited to these examples and can include other suitable functionality in other implementations.

In some implementations, memory 904G can receive and/or store information and instructions for enabling UE 210, and/or one or more components thereof, to support lightweight wakeup with a token. For example, the information and instructions can cause and/or enable UE 210 to receive a token created by a token server. UE 210 can share the token with cellular gateway function and origin server, and share the UE ID with the cellular gateway function. Cellular gateway function can maintain a table mapping the token to the UE ID, and facility routing of notification information from the origin server to UE 210. UE 210 can receive a lightweight wakeup, such as a page message, and determine whether to enter a wake state and retrieve the notification data from the origin server. These and many other features and examples are described herein.

In some implementations, the baseband circuitry 904 can include one or more audio digital signal processor(s) (DSP) 904F. The audio DSPs 904F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 904 and the application circuitry 902 can be implemented together such as, for example, on a system on a chip (SOC).

In some implementations, the baseband circuitry 904 can provide for communication compatible with one or more radio technologies. For example, in some implementations, the baseband circuitry 904 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 904 is configured to support radio communications of more than one wireless protocol can be referred to as multi-mode baseband circuitry.

RF circuitry 906 can enable communication with wireless networks using modulated electromagnetic radiation through a non-solid medium. In various implementations, RF circuitry 806 can include switches, filters, amplifiers, etc., to facilitate the communication with the wireless network. RF circuitry 906 can include a receive signal path which can include circuitry to down-convert RF signals received from FEM circuitry 98 and provide baseband signals to baseband circuitry 904. RF circuitry 906 can also include a transmit signal path which can include circuitry to up-convert baseband signals provided by baseband circuitry 804 and provide RF output signals to FEM circuitry 98 for transmission.

In some implementations, the receive signal path of the RF circuitry 906 can include mixer circuitry 906A, amplifier circuitry 906B and filter circuitry 906C. In some implementations, the transmit signal path of RF circuitry 906 can include filter circuitry 906C and mixer circuitry 906A. RF circuitry 906 can also include synthesizer circuitry 906D for synthesizing a frequency for use by mixer circuitry 906A of the receive signal path and the transmit signal path. In some implementations, mixer circuitry 906A of the receive signal path can be configured to down-convert RF signals received from FEM circuitry 98 based on the synthesized frequency provided by synthesizer circuitry 906D. Amplifier circuitry 906B can be configured to amplify the down-converted signals and filter circuitry 906C can be a low-pass filter (LPF) or band-pass filter (BPF) configured to remove unwanted signals from the down-converted signals to generate output baseband signals. Output baseband signals can be provided to baseband circuitry 904 for further processing. In some implementations, the output baseband signals can be zero-frequency baseband signals, although this may not be a requirement. In some implementations, mixer circuitry 906A of the receive signal path can comprise passive mixers, although the scope of the implementations is not limited in this respect.

In some implementations, the mixer circuitry 906A of the transmit signal path can be configured to up-convert input baseband signals based on the synthesized frequency provided by the synthesizer circuitry 906D to generate RF output signals for the FEM circuitry 98. The baseband signals can be provided by the baseband circuitry 904 and can be filtered by filter circuitry 906C.

In some implementations, mixer circuitry 906A of the transmit signal path can be configured to up-convert input baseband signals based on the synthesized frequency provided by synthesizer circuitry 906D to generate RF output signals for FEM circuitry 98. The baseband signals can be provided by baseband circuitry 904 and can be filtered by filter circuitry 906C. In some implementations, mixer circuitry 906A of the receive signal path and mixer circuitry 906A of the transmit signal path can include two or more mixers and can be arranged for quadrature down conversion and up conversion, respectively. In some implementations, mixer circuitry 906A of the receive signal path and mixer circuitry 906A of the transmit signal path can include two or more mixers and can be arranged for image rejection. In some implementations, mixer circuitry 906A of the receive signal path and mixer circuitry 906A can be arranged for direct down conversion and direct up conversion, respectively. In some implementations, mixer circuitry 906A of the receive signal path and mixer circuitry 906A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, RF circuitry 906 can include analog-to-digital converter (ADC) and digital-to-analog converter (DAC) circuitry and baseband circuitry 904 can include a digital baseband interface to communicate with RF circuitry 906.

In some dual-mode implementations, a separate radio IC circuitry can be provided for processing signals for each spectrum, although the scope of the implementations is not limited in this respect. In some implementations, the synthesizer circuitry 906D can be a fractional-N synthesizer or a fractional N/N+1 synthesizer, although the scope of the implementations is not limited in this respect as other types of frequency synthesizers can be suitable. For example, synthesizer circuitry 906D can be a delta-sigma synthesizer, a frequency multiplier, or a synthesizer comprising a phase-locked loop with a frequency divider.

Synthesizer circuitry 906D can be configured to synthesize an output frequency for use by mixer circuitry 906A of RF circuitry 906 based on a frequency input and a divider control input. In some implementations, synthesizer circuitry 906D can be a fractional N/N+1 synthesizer. In some implementations, frequency input can be provided by a voltage-controlled oscillator (VCO). Divider control input can be provided by either baseband circuitry 904 or the applications circuitry 902 depending on the desired output frequency. In some implementations, a divider control input (e.g., N) can be determined from a look-up table based on a channel indicated by the applications circuitry 902.

Synthesizer circuitry 906D of RF circuitry 906 can include a divider, a delay-locked loop (DLL), a multiplexer, and a phase accumulator. In some implementations, the divider can be a dual modulus divider (DMD), and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 906D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, RF circuitry 906 can include an in-phase/quadrature (I/Q)/polar converter.

FEM circuitry 98 can include a receive signal path which can include circuitry configured to operate on RF signals received from one or more antennas 910, amplify the received signals and provide the amplified versions of the received signals to RF circuitry 906 for further processing. FEM circuitry 98 can also include a transmit signal path which can include circuitry configured to amplify signals for transmission provided by RF circuitry 906 for transmission by one or more of the one or more antennas 910. In various implementations, the amplification through the transmit or receive signal paths can be done solely in RF circuitry 906, solely in FEM circuitry 98, or in both RF circuitry 906 and FEM circuitry 98.

In some implementations, the FEM circuitry 98 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 906). The transmit signal path of the FEM circuitry 98 can include a power amplifier (PA) to amplify input RF signals (e.g., provided by RF circuitry 906), and one or more filters to generate RF signals for subsequent transmission (e.g., by one or more of the one or more antennas 910).

In some implementations, the PMC 912 can manage power provided to the baseband circuitry 904. In particular, PMC 912 can control power-source selection, voltage scaling, battery charging, or direct current (DC) to DC (DC-to-DC) conversion. PMC 912 can often be included when device 900 is capable of being powered by a battery, for example, when device 900 is included in a UE. PMC 912 can increase the power conversion efficiency while providing desirable implementation size and heat dissipation characteristics.

While FIG. 9 shows PMC 912 coupled only with the baseband circuitry 904, in other implementations, PMC 912 can be additionally or alternatively coupled with, and perform similar power management operations for, other components such as, but not limited to, application circuitry 902, RF circuitry 906, or FEM circuitry 98.

In some implementations, the PMC 912 can control, or otherwise be part of, various power saving mechanisms of device 900. For example, if device 900 is in an RRC_Connected state, where device 900 is still connected to the RAN node as device 900 expects to receive traffic shortly, then device 900 can enter a state known as discontinuous reception mode (DRX) after a period of inactivity. During this state, device 900 can power down for brief intervals of time and thus save power.

If there is no data traffic activity for an extended period of time, then device 900 can transition off to an RRC_Idle state, where device 900 disconnects from the network and does not perform operations such as channel quality feedback, handover, etc. Device 900 can go into a very low power state (e.g., power saving mode) and device 900 can perform paging where again device 900 periodically can wake up to listen to the network and then power down again. Device 900 may not receive data in this state; in order to receive data, device 900 can transition back to RRC_Connected state.

An additional power saving mode can allow a device to be unavailable to the network for periods longer than a paging interval (ranging from seconds to a few hours). During this time, the device 900 can be unreachable to the network and can power down completely. Any data sent during this time can incur a large delay and device 900 can assume the delay is acceptable.

Processors of application circuitry 902 and processors of baseband circuitry 904 can be used to execute elements of one or more instances of a protocol stack. For example, processors of baseband circuitry 904, alone or in combination, can be used execute Layer 3, Layer 2, or Layer 1 functionality, while processors of baseband circuitry 904 can utilize data (e.g., packet data) received from these layers and further execute Layer 4 functionality (e.g., transmission communication protocol (TCP) and user datagram protocol (UDP) layers). As referred to herein, Layer 3 can comprise a radio resource control layer. As referred to herein, Layer 2 can comprise a medium access control layer, a radio link control layer, and a packet data convergence protocol layer, described in further detail below. As referred to herein, Layer 1 can comprise a physical layer of a UE/RAN node.

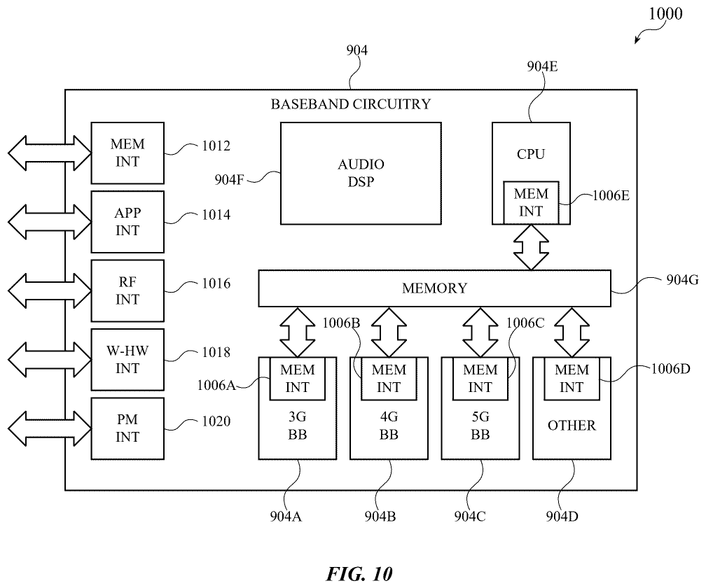

FIG. 10 is a diagram of example interfaces 1000 of baseband circuitry according to one or more implementations described herein. One or more components or features of example interfaces 1000 can correspond to one or more components or features described above or elsewhere. Baseband circuitry 1004 can comprise processors 1004A, 1004B, 1004C, 1004D, and 1004E and a memory 1004G utilized by said processors. Each of the processors 1004A, 1004B, 1004C, 1004D, and 1004E can include a memory interface, 1006A, 1006B, 1006C, 1006D, and 1006E, respectively, to send/receive data to/from the memory 1004G. Baseband circuitry can be a component of a UE and/or another type of device or system capable of transmitting and/or receiving wireless signals.

In some implementations, memory 1004G can receive, store, and/or provide information and instructions for supporting lightweight wakeup with a token. For example, a token can be created, stored, and selectively shared with various entities. The UE ID can similarity be shared selectively with various entities. An entity, such as a cellular gateway function, can maintain a mapping of the token and UE ID to facilitate routing of information from entities with the token to entities with the UE ID.

Baseband circuitry 1004 can further include one or more interfaces to communicatively couple to other circuitries/devices, such as a memory interface 1012 (e.g., an interface to send/receive data to/from memory external to baseband circuitry 1004), an application circuitry interface 1014 (e.g., an interface to send/receive data to/from the application circuitry as described herein), an RF circuitry interface 1016, a wireless hardware connectivity interface 1018 (e.g., an interface to send/receive data to/from Near Field Communication (NFC) components, Bluetooth® components (e.g., Bluetooth® Low Energy), Wi-Fi® components, and other communication components), and a power management interface 1020 (e.g., an interface to send/receive power or control signals to/from a PMC)

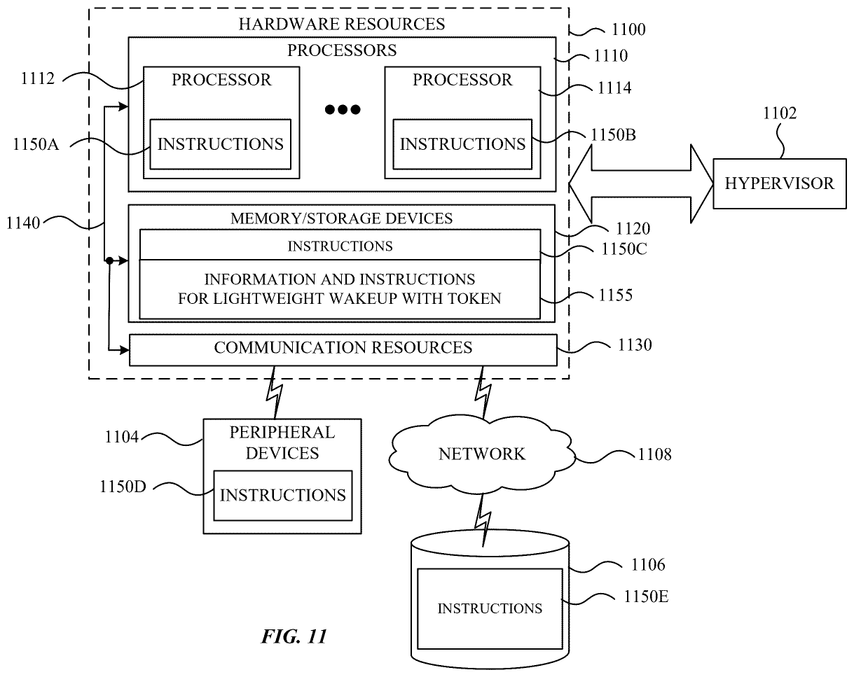

FIG. 11 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1100 including one or more processors 1110 (or processor cores), one or more memory/storage devices 1120, and one or more communication resources 1130, each of which can be communicatively coupled via a bus 1140. For implementations where node virtualization or network function virtualization is utilized, a hypervisor can be executed to provide an execution environment for one or more network slices/sub-slices to utilize hardware resources 1100. Hardware resources 1100 can interact with hypervisor 1102. For example, hypervisor 1102 can schedule or otherwise manage hardware resource 1100.

The processors 1110 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 1112 and a processor 1114.

The memory/storage devices 1120 can include main memory, disk storage, or any suitable combination thereof. The memory/storage devices 1120 can include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1120 receive and/or store information and instructions 1155 for lightweight wakeup with a token. For example, the token and UE ID can be shared with and stored by some entities. In some examples, an entity, such as a cellular gateway function, can store a mapping of the token and UE ID and facilitate routing of information between entities. Routing of information can be completed via secure tunnels and lightweight wakeup messages, such as poke messages and paging messages. These and many other features and examples are discussed herein.

Communication resources 1130 can include interconnection or network interface components or other suitable devices to communicate with one or more peripheral devices 1104 or one or more databases 1106 via a network 118. For example, communication resources 1130 can include wired communication components (e.g., for coupling via a universal serial bus), cellular communication components, near field communication components, Bluetooth® components (e.g., Bluetooth® Low Energy), Wi-Fi® components, and other communication components.

Instructions 1150A, 1150B, 1150C, 1150D, and/or 1150E can comprise software, a program, an application, an applet, an app, or other executable code for causing at least any of processors 1110 to perform any one or more of the methodologies discussed herein. Instructions 1150 can reside, completely or partially, within at least one of processors 1110 (e.g., within a cache memory), memory/storage devices 1120, or any suitable combination thereof. Furthermore, any portion of instructions 1150A-E can be transferred to hardware resources 1100 from any combination of peripheral devices 1104 or databases 1106. Accordingly, memory of processors 1110, memory/storage devices 1120, peripheral devices 1104, and databases 1106 are examples of computer-readable and machine-readable media.

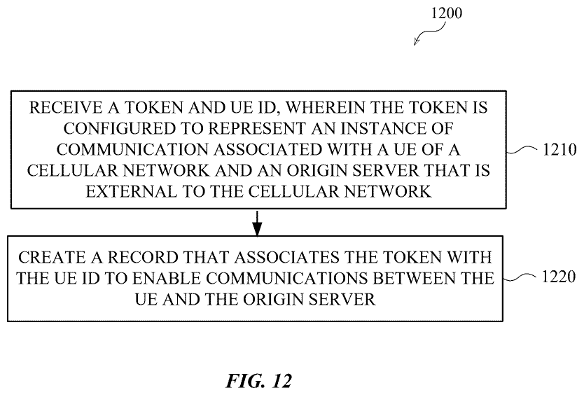

FIG. 12 is a diagram of an example process for lightweight wakeup with a token according to one or more implementations described herein. Process 1200 can be implemented by cellular gateway function (e.g., cellular gateway function 615, cellular gateway function server). In some implementations, some or all of process 1200 can be performed by one or more other systems or devices, including one or more of the devices of FIG. 2. Additionally, process 1200 can include one or more fewer, additional, differently ordered and/or arranged operations than those shown in FIG. 12. In some implementations, some or all of the operations of process 1200 can be performed independently, successively, simultaneously, etc., of one or more of the other operations of process 1200. As such, the techniques described herein are not limited to a number, sequence, arrangement, timing, etc., of the operations or processes depicted in FIG. 12.

Process 1200 can include receiving a token and UE ID, wherein the token is configured to represent an instance of communication associated with a UE of a cellular network and an origin server that is external to the cellular network (block 1210). Process 1200 can include creating a record (e.g., mapping) that associates the token with the UE ID to enable communications between the UE and the origin server (block 1220).

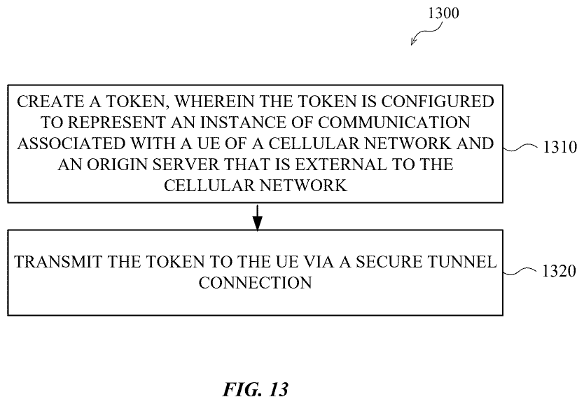

FIG. 13 is a diagram of an example process for lightweight wakeup with a token according to one or more implementations described herein. Process 1300 can be implemented by one or more server devices (e.g., token server 620). In some implementations, some or all of process 1300 can be performed by one or more other systems or devices, including one or more of the devices of FIG. 2. Additionally, process 1300 can include one or more fewer, additional, differently ordered and/or arranged operations than those shown in FIG. 13. In some implementations, some or all of the operations of process 1300 can be performed independently, successively, simultaneously, etc., of one or more of the other operations of process 1300. As such, the techniques described herein are not limited to a number, sequence, arrangement, timing, etc., of the operations or processes depicted in FIG. 13.

Process 1300 can include creating a token, wherein the token is configured to represent an instance of communication associated with UE 210 of a cellular network and an origin server that is external to the cellular network (block 1310). Process 1300 can include transmitting the token to UE 210 via a secure tunnel connection (block 1320).

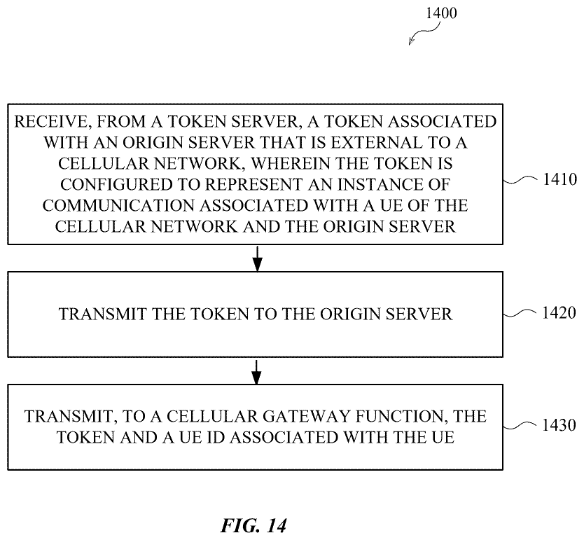

FIG. 14 is a diagram of an example process for lightweight wakeup with a token according to one or more implementations described herein. Process 1400 can be implemented by UE 210. In some implementations, some or all of process 1400 can be performed by one or more other systems or devices, including one or more of the devices of FIG. 2. Additionally, process 1400 can include one or more fewer, additional, differently ordered and/or arranged operations than those shown in FIG. 14. In some implementations, some or all of the operations of process 1400 can be performed independently, successively, simultaneously, etc., of one or more of the other operations of process 1400. As such, the techniques described herein are not limited to a number, sequence, arrangement, timing, etc., of the operations or processes depicted in FIG. 14.

Process 1400 can include receiving, from a token server (e.g., one or more server devices), a token associated with an origin server that is external to a cellular network, wherein the token is configured to represent an instance of communication associated with UE 210 of the cellular network and the origin server (block 1410). Process 1400 can include transmit the token to the origin server (block 1420). Process 1400 can include transmitting, to a cellular gateway function, the token and a UE ID associated with UE 210 (block 1430).

Examples and/or implementations herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which can also include one or more of the examples described herein, a cellular gateway function can comprise: a memory; and one or more processors configured to, when executing instructions stored in the memory, cause the cellular gateway function to: receive a token and UE ID, wherein the token is configured to represent an instance of communication associated with a UE of a cellular network and an origin server that is external to the cellular network; create a record that associates the token with the UE ID to enable communications between the UE and the origin server.

In example 2, which can also include one or more of the examples described herein, the record further comprises index values, one or more UE IDs, one or more tokens associated with one or more UE IDs, and one or more port statuses associated with each respective UE ID.

In example 3, which can also include one or more of the examples described herein, the one or more processors are further configured to cause the cellular gateway function to: receive a first poke message from a token server, the first poke message comprising the token and a notification, wherein the notification indicates notification data for the UE at the origin server, and wherein the token server is one of one or more server devices.

In example 4, which can also include one or more of the examples described herein, the one or more processors are further configured to cause the cellular gateway function to: identify the UE ID associated with the token via the token mapping; and transmit a second poke message to a cellular network, the second poke message comprising the notification and UE ID.

In example 5, which can also include one or more of the examples described herein, the first poke message is a lightweight wakeup message and the second poke message is a lightweight wakeup message.

In example 6, which can also include one or more of the examples described herein, the token is associated with an origin and comprises cellular carrier identifying data, delay thresholds, cellular network connection data, and secured UE identification data.

In example 7, which can also include one or more of the examples described herein, one or more server devices (e.g., token server) can comprise: a memory; and one or more processors configured to, when executing instructions stored in the memory, cause the token server to: create a token, the token representing an instance of communication associated with a UE and an origin server, wherein the token server is one of one or more server devices; and transmit the token to the UE via a secure tunnel connection.

In example 8, which can also include one or more of the examples described herein, the one or more processors are further configured to cause the token server to: receive a token request from the UE via a secure tunnel connection, wherein the token request identifies the origin server; and transmit the token based on the token request.

In example 9, which can also include one or more of the examples described herein, the one or more processors are further configured to cause the one or more server devices to: receive a message from the origin server, the message comprising the token and a notification for the UE at the origin server.

In example 10, which can also include one or more of the examples described herein, the one or more processors are further configured to cause the one or more server devices to: transmit a poke message, to a cellular gateway function and a via a secure tunnel communication based on receiving the token from the origin server, the poke message comprising the notification and token.

In example 11, which can also include one or more of the examples described herein, the token comprises cellular carrier identifying data, delay thresholds, cellular network connection data, and secured UE identification data.

In example 12, which can also include one or more of the examples described herein, the origin server comprises the token server, the one or more server devices, or a combination thereof.

In example 13, which can also include one or more of the examples described herein, a UE can comprise: a memory; and one or more processors configured to, when executing instructions stored in the memory, cause the UE to: receive, from a token server, a token associated with an origin server, the token representing an instance of communication associated with the UE and the origin server; transmit the token to the origin server; and transmit, to a cellular gateway function, the token and a UE identifier (ID) associated with the UE.

In example 14, which can also include one or more of the examples described herein, the one or more processors are further configured to cause the UE to: transmit a token request to the token server via a secure tunnel, wherein the token request identifies the origin server; and receive the token based on the token request.

In example 15, which can also include one or more of the examples described herein, the one or more processors are further configured to cause the UE to: receive, from a base station and while in a power saving mode, a lightweight wakeup message comprising the UE ID and a notification routed from the origin server.

In example 16, which can also include one or more of the examples described herein, the one or more processors are further configured to cause the UE to: determine to continue in a power saving mode based on the lightweight wakeup message; and transmit a first message of a RACH procedure, wherein the first message acknowledges receipt of the lightweight wakeup message.

In example 17, which can also include one or more of the examples described herein, the one or more processors are further configured to cause the UE to: enter an active mode in response to the lightweight wakeup message; and establish a connection with the base station.

In example 18, which can also include one or more of the examples described herein, the one or more processors are further configured to cause the UE to: receive MT data from a base station; and transmit MO data to the base station.

In example 19, which can also include one or more of the examples described herein, the one or more processors are further configured to cause the UE to: transmit, based on the lightweight wakeup message, a data message to the origin server; and receive, in response to the data message, notification data from the origin server.

In example 20, which can also include one or more of the examples described herein, the one or more processors are further configured to cause the UE to: release the connection established with the base station based on receiving the notification data.

In example 21, which can also include one or more of the examples described herein, the one or more server devices comprise at least one of: a token server, a cellular gateway function, the origin server, or a combination thereof.

In example 22, which can also include one or more of the examples described herein, the one or more processors are configured to cause the one or more server devices to: transmit the token to the UE via a secure tunnel connection.

The examples discussed above also extend to method, computer-readable medium, and means-plus-function claims and implementations, any of which can include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature can have been disclosed with respect to only one of several implementations, such feature can be combined with one or more other features of the other implementations as can be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising. ” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A cellular gateway function, comprising:
a memory; and
one or more processors configured to, when executing instructions stored in the memory, cause the cellular gateway function to:
receive a token and user equipment (UE) identifier (ID), wherein the token is configured to represent an instance of communication associated with a UE of a cellular network and an origin server that is external to the cellular network; and
create a record that associates the token with the UE ID to enable communications between the UE and the origin server.

2. The cellular gateway function of claim 1, wherein the record further comprises index values, one or more UE IDs, one or more tokens associated with one or more UE IDs, and one or more port statuses associated with each respective UE ID.

3. The cellular gateway function of claim 1, wherein the one or more processors are further executable to cause the cellular gateway function to:
receive a first poke message from a token server, the first poke message comprising the token and a notification, wherein the notification indicates notification data for the UE at the origin server, and wherein the token server is one of one or more server devices.

4. The cellular gateway function of claim 3, wherein the one or more processors are further executable to cause the cellular gateway function to:
identify the UE ID associated with the token via the token mapping; and
transmit a second poke message to a cellular network, the second poke message comprising the notification and UE ID.

5. The cellular gateway function of claim 4, wherein the first poke message is a first lightweight wakeup message and the second poke message is a second lightweight wakeup message.

6. The cellular gateway function of claim 1, wherein the token is associated with an origin and comprises cellular carrier identifying data, delay thresholds, cellular network connection data, and secured UE identification data.

7. One or more server devices, comprising:
a memory; and
one or more processors configured to, when executing instructions stored in the memory, cause the one or more server devices to:
create a token, wherein the token is configured to represent an instance of communication associated with a user equipment (UE) of a cellular network and an origin server that is external to the cellular network; and
transmit the token to the UE via a secure tunnel connection.

8. The one or more server devices of claim 7, wherein the one or more server devices comprise at least one of:
a token server,
a cellular gateway function,
the origin server, or
a combination thereof.

8. The one or more server devices of claim 7, wherein the one or more processors are further executable to cause the one or more server devices to:
receive a token request from the UE via a secure tunnel connection, wherein the token request identifies the origin server; and
transmit the token based on the token request, wherein the token is transmitted to the UE via the secure tunnel connection.

9. The one or more server devices of claim 7, wherein the one or more processors are further executable to cause the one or more server devices to:
receive a message from the origin server, the message comprising the token and a notification for the UE at the origin server.

10. The one or more server devices of claim 10, wherein the one or more processors are further executable to cause the one or more server devices to:
transmit a poke message to a cellular gateway function and a via a secure tunnel communication based on receiving the token from the origin server, the poke message comprising the notification and the token.

11. The one or more server devices of claim 7, wherein the token comprises cellular carrier identifying data, delay thresholds, cellular network connection data, and secured UE identification data.

12. The one or more server devices of claim 7, wherein the origin server comprises a token server, the one or more server devices, or a combination thereof.

13. A user equipment (UE), comprising:
a memory; and
one or more processors configured to, when executing instructions stored in the memory, cause the UE to:
receive, from a token server, a token associated with an origin server that is external to a cellular network, wherein the token is configured to represent an instance of communication associated with a user equipment (UE) of the cellular network and the origin server;
transmit the token to the origin server; and
transmit, to a cellular gateway function, the token and a UE identifier (ID) associated with the UE.

14. The UE of claim 14, wherein the one or more processors are further configured to cause the UE to:
transmit a token request to the token server via a secure tunnel, wherein the token request identifies the origin server; and
receive the token based on the token request, wherein the token is transmitted to the UE via a secure tunnel connection.

15. The UE of claim 14, wherein the one or more processors are further configured to cause the UE to:
receive, from a base station and while in a power saving mode, a lightweight wakeup message comprising the UE ID and a notification routed from the origin server.

16. The UE of claim 16, wherein the one or more processors are further configured to cause the UE to:
determine to continue in the power saving mode based on the lightweight wakeup message; and
transmit a first message of a random access control channel (RACH) procedure, wherein the first message acknowledges receipt of the lightweight wakeup message.

17. The UE of claim 16, wherein the one or more processors are further configured to cause the UE to:
enter an active mode in response to the lightweight wakeup message; and
establish a connection with the base station.

18. The UE of claim 18, wherein the one or more processors are further configured to cause the UE to:
transmit, based on the lightweight wakeup message, a data message to the origin server; and
receive, in response to the data message, notification data from the origin server.

19. The UE of claim 19, wherein the one or more processors are further configured to cause the UE to:
release the connection established with the base station based on receiving the notification data.
